(19) United States
(12) Patent Application Publication
(10) Pub. No.: US 2020/0220447 A1
(43) Pub. Date: Jul. 9, 2020

(54) Magnetic Repulsion Motor & Generator

(71) Applicant: JONATHAN BANNON MAHER CORPORATION, Ridgewood, NJ (US)

(72) Inventor: Jonathan Bannon MAHER, Ridgewood, NJ (US)

(21) Appl. No.: 16/624,144

(22) PCT Filed: Jun. 19, 2018
(86) PCT No.: PCT/US18/38208

§ 371 Date: Dec. 18, 2019

Related U.S. Application Data
(60) Provisional application No. 62/522,653, filed on Jun. 20, 2017.
(60) Provisional application No. 62/596,823, filed on Dec. 9, 2017.
(60) Provisional application No. 62/631,640, filed on Feb. 17, 2018.
(60) Provisional application No. 62/645,077, filed on Mar. 19, 2018.

(51) Int. Cl. H02K 53/00

(52) U.S. Cl. CPC H02K 53/00

(57) ABSTRACT

Systems, methods, apparatuses, and in some embodiments computer programs encoded on a computer storage medium, provide for clean continuous portable self-contained physics powered propulsion and electricity generation, utilizing repulsive magnetic fields, where in some embodiments, including one complete embodiment, a first structure holding magnetic fields is able to be engaged inside or around a complimentary second structure holding magnetic fields, with magnetic fields angled, spaced, and shielded to allow one or both structures to spin continuously, where speed and force may be determined by percent the two structures are engaged, with the structures rotation in turn providing electricity generator axle rotation and or providing the propulsion of a traditional motor.

### REFERENCE TO RELATED DOCUMENTS

This application is provided the benefit and priority date of the United States Patent and Trademark Office provisional patent applications 62/522,653, filed Jun. 20, 2017 by inventor Jonathan Bannon Maher, 62/596,823, filed Dec. 9, 2017 by inventor Jonathan Bannon Maher, 62/631,640 filed Feb. 17, 2018 by inventor Jonathan Bannon Maher, and 62/645,077 filed Mar. 19, 2018 by inventor Jonathan Bannon Maher, which are incorporated herein in their entirety.

### TECHNICAL FIELD

Embodiments of the invention relate to the fields of motors, generators, physics, engineering, and programming.

### BACKGROUND

The majority of the inventor's proceeds from the licensing of this patent will ultimately be going to causes that support the well being of humanity, and your support in ensuring the patent is forever in every way as strong as possible, will be providing a service to all the world.

This section is intended to introduce the reader to various aspects of the art that may be related to various aspects of the present techniques, which are described and or claimed. This discussion is believed to be helpful in providing the reader with background information to facilitate a better understanding of the various aspects of the present disclosure. Accordingly, it is understood that these statements are to be read in this light, and not a citation of any prior art.

Patent filings on structurally differentiated and fundamentally deficient disclosures may exist that may attempt to claim any invention that is self-powered, based on previously publicly known failed attempts to build such devices, however any such disclosures do not enable the purported inventions, with overly broad claims not supported by the disclosure that also fail to distinctly claim the invention, and any such patent filings are inherently invalidated by prior public disclosure, the enablement requirement, and the claims support requirement.

Known and proposed energy production, transmission, and storage systems have some or all of the following deficiencies:

1. External fuel source required: an external fuel source is utilized such as oil, gas, coal, wind, sun, water currents, geothermal heat, hydrogen, or uranium, where the cost of providing fuel in the form of electricity or gasoline to a vehicle over its useful life potentially exceeds the cost of the vehicle, and about a quarter of airline costs are from fuel.

2. Environmentally unfriendly: nuclear energy production, including fission, fusion, and cold (LENR), results in toxic waste and or materials, geothermal often circulates contaminants from the ground, fracking creates toxic water, hydroelectric dams decompose organic matter producing the potent global warming gas methane, solar panel manufacturing often releases toxic byproducts including greenhouse gases far more potent and long lived than those from fossil fuels, hydrogen takes substantially more energy to produce and transport than it provides, while clean energy sources may utilize slowly degrading flammable toxic batteries to store energy for when the sun is not shining, wind is not blowing, or water is not adequately flowing.

3. Intermittent: wind, solar, and traditional water energy systems provide variable output, with average output often found to be around 20% of rated output, as a result of environmental conditions, meaning a 5 kilowatt system typically produces average output of only 1 kilowatt.

4. Not portable: solar panels can only function in the sun, wind turbines in wind, water turbines in water currents, nuclear in a stable highly controlled environment, and carbon with the aid of an emissions pipe.

5. Extremely expensive transmission costs: power lines are required for all forms of nuclear energy, including fission, fusion and cold, for farms of solar, wind, and water, and for fossil fuels plants, while pipelines are generally required for oil and gas, including natural gas, which is principally methane, a greenhouse gas more than twenty times more potent than carbon dioxide that may be leaked during extraction, transport, and consumption. Power line and fossil fuel pipe line cost of installation per 1 mile (1.6 kilometers) has been found to be up to around 20 times the average annual income in the United States, and lines must be replaced every 30 to 50 years, so in the United States alone, with 300 thousand miles (480 thousand kilometers) of power lines, and 200 thousand miles (320 thousand kilometers) of pipelines, replacement would require an expenditure around 25 times the national debt, passed on to consumers, and dragging down the economy, with every other developed nation in a similar situation. Power lines require environmental destruction during installation, leave visible blight, are forever vulnerable to cyber attacks, transmit power from central sites that are inherently more prone to failure and blackout than a decentralized system, dissipate power during transmission, with high voltage power lines having health consequences for those living nearby.

6. High initial costs: in addition to previously cited expense of power lines, fossil fuel pipes, and ongoing fuel costs, clean energy farms require an allocation of land, and degrading batteries requiring periodic replacement, which is why tax credits are often required for clean energy systems to be affordable. In addition to those factors, comparing a 1 kilowatt rated clean energy system to a 1 kilowatt rated traditional system, may require multiplying the cost of the clean energy system by approximately 10 times, 5 times to account for enough electricity generation to be stored for the equivalent continuous output, and 5 times for the battery storage.

7. Vulnerable to weather: wind turbines, hydroelectric dams, and solar panels, can be made ineffective by environmental conditions such as freezing temperatures, snow, and rain, and similar to power lines, may be taken down by extreme weather and lightning strikes.

8. Vulnerable to black outs: power transmitted over power lines creates vulnerability for critical facilities such as hospitals and data centers.

9. Vulnerable to cyber attack: utility scale energy systems often require a hackable computer to operate, and are therefore forever vulnerable to computer viruses able to take down and or destroy nuclear power plants and the electrical grid, even if such systems aren't connected to the Internet, as demonstrated by the Stuxnet virus.

10. Causes deaths: plants, rigs, and pipes, for current and proposed forms of nuclear, hydrogen, gas, and oil energy can explode, and coal mines can collapse, while wildlife is killed by wind, ocean, wave, and river turbines, hydroelectric dams, solar condensers, solar panel and battery manufacturing byproducts, and nuclear waste.

11. Encourage nuclear weapon proliferation: fission, fusion, and cold (LENR) nuclear energy are or can be one step from weaponizable, while hydrogen can be obtained by a terrorist at a hydrogen fuel station to create a powerful compressed hydrogen explosion, as verified by reviewing a video of a balloon filled with hydrogen being lit on fire. Fusion is particularly disturbing, as a fusion weapon could be created with the power of an exploding star, able to take out the planet, and resulting in an extinction level event for humans, a scenario even more likely when considering increasingly autonomous—and therefore inevitably hackable by individuals—weapons control.

### BRIEF DESCRIPTION OF THE ILLUSTRATIONS

Illustrations are presented by way of example, and not by way of limitation, where some embodiments may not contain all components, may contain additional components, and may contain functionally similar components.

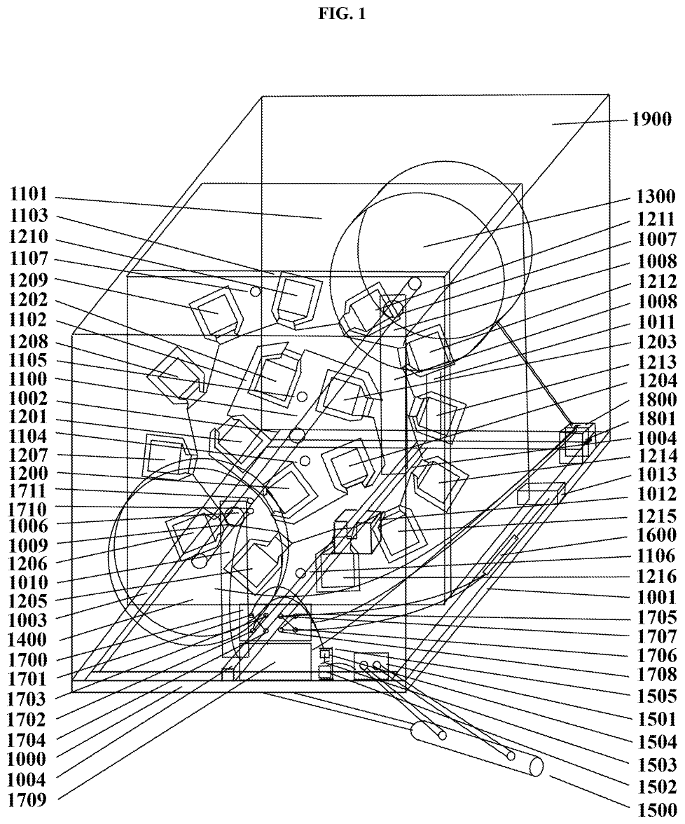

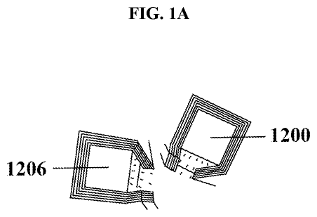

FIG. 1 is an illustration of an example of an embodiment, with a rotatable magnet structure inside a rotationally fixed outer magnet structure, with all magnets angled, spaced, and insulated, to provide magnetic repulsion to rotate one of the magnet structures to spin an electricity generator and or motor axle.

FIG. 1A is an illustration of a magnified view of part of the magnetic fields of a pair of magnets in FIG. 1.

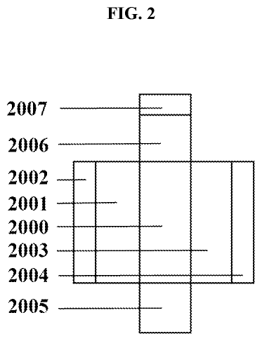

FIG. 2 is an illustration of an example of an embodiment of a pattern which may be used to form insulation material that directs a magnetic field.

### DETAILED DESCRIPTION

The disclosure is related to the field of clean continuous portable self-powered energy and propulsion. It is understood that any reference to a person skilled in the art, recognizes that at the time of filing, there is no one else skilled in the art of this particular field, or a closely related field. Given the extraordinary nature of the disclosure, regardless of how full, clear, concise and exact the disclosure in enabling the production and use of embodiments of the disclosure, what could be construed to be undue experimentation during production and use, is simply the ordinary effort required in the assembly and use of an embodiment of such a disclosure.

It is understood that, as in any engineering or design project, the development of any actual implementation will include numerous implementation specific decisions made to achieve the developers' specific goals, such as compliance with business related and system related constraints, which may vary from one implementation to another. It is understood that such a development effort might be complex and time consuming, but is nevertheless a routine undertaking of design, fabrication, and manufacture for those skilled in the art having the benefit of this disclosure. The disclosed steps may be read as prefaced by “In some embodiments, including one complete embodiment,”, may be executed or performed in other orders or sequences, and are not limited to the order and sequence shown and described, which are provided to enable ease in constructing an embodiment, and along with each components of each step, may be removed, modified, combined, or rearranged, and other steps and or step components may be added, without departing from the scope of this disclosure and or invention. Although embodiments of the invention have been described and illustrated in the disclosed implementations, it is understood that the present disclosed subject matter, including apparatuses, methods, specification, and illustrations, has been made only by way of example, not by way of limitation, and the methods and apparatuses may be used in other systems, and that numerous changes and optimizations in the details of implementation of the invention and or embodiment are made without such modifications departing from the spirit and scope of this disclosure and or embodiments of the invention. Although the disclosure has been shown and described with respect to one or more embodiments, features of the disclosed embodiments can be combined and rearranged in various ways, and changes including equivalent alterations, substitutions, modifications, and additional efficiencies will of course occur to someone of ordinary skill in the art without departing from the spirit and scope of this disclosure and or invention. In particular regard to the various functions performed by the described components, the terms used to describe such components are intended to correspond, unless otherwise indicated, to any component which performs the specified function of the described component, or is functionally equivalent to the described component, even though not structurally equivalent to the disclosed structure which performs the function in the implementations described in this disclosure. In addition, while a particular feature of the disclosure may have been provided with respect to only one of several embodiments, such feature may be combined with one or more other features of other embodiments as may be desired and advantageous for any given or particular application. In some instances, well-known circuits, structures and techniques have not been shown in detail in order not to obscure the understanding of this disclosure. Articles in this disclosure such as “a” “an” and “the” may allow for both singular and plural forms. Verbs in this disclosure such as “is” may be read as “may be”. Conjunctions in this disclosure such as “or” as used herein may be interpreted as inclusive or meaning any one or any combination, where “A, B or C” means “any of the following: A; B; C; A and B; A and C; B and C; A, B and C”. Relational terms in this disclosure, for example first and second, top and bottom, left and right, are to distinguish one entity or action from another, and may not necessarily require or imply a relationship, or order between, such entities or actions. The disclosure includes the best mode contemplated by the inventor, a completely described specific embodiment, along with optional components and alternative embodiments to best suit the implementer, measurements in imperial and metric units to support universal understanding, and dramatically exceeds claims support requirements and enablement requirements by allowing for selection and or construction of the required components to be carried out easily, quickly, and routinely by persons of ordinary skill in the art, who are provided the additional benefit of utilizing readily available commodity components whenever possible. The present disclosure includes material protected by copyrights, and the owner of the copyrights hereby reserves all rights, but with authorization for publication as required by government patent offices. Various embodiments of the present invention may provide all, some or none of the disclosed technical advantages.

The computer code descriptions disclosed, in order to provide comprehensive enabling disclosure, rather than utilizing flow charts, which according to Patent Cooperation Treaty 11.11a are prohibited from containing “text matter, except a single word or words, when absolutely indispensable, such as . . . a few short catchwords indispensable for understanding”, are provided in a text only format where the number of arrows preceding a line indicate logical block level, semicolons indicate a new segment of a logical block, and periods indicate the closure of one or more logical blocks. It is understood that any computer code representations in this disclosure are merely illustrative, rather than restrictive. While code may be written in nearly any computer language, including Java and C++, the illustrative computer code descriptions were derived from code written the Python language, which may be run through the Python interpreter, with appropriate supportive libraries, which at the time of disclosure, may run on nearly any computer, for example one with an Intel or AMD processor, running a current version of Linux, Windows, or Mac OS. All code components may read as if prefaced by “In some embodiments, including one complete embodiment,”. In some embodiments, functionality may be modified, rearranged, excluded, and added. To provide more fundamental computer system details, in some embodiments, the functionality associated with the disclosed computer code descriptions may be referred to as a script, module, software, software application, or code, and can be written in any form of language, including compiled, interpreted, declarative, or procedural, able to be deployed in any form suitable for use in a computing environment, including as an independent or integrated program, module, component, or subroutine, for execution by the computer system, implemented on one or more independent or integrated computers, utilizing a central processing unit in the form of one or more general or special purpose microprocessors, in conjunction with digital electronic circuitry, which may include special purpose logic circuitry such as a field programmable gate array or application specific integrated circuit, with the computer controlled by and operatively coupled to tangibly embodied software and or firmware, which may include code that creates an environment for code execution, including individual or combined use of processor firmware, a protocol stack, a database management system, and an operating system, where such software and or firmware may exist in one or more parts in memory on one or more computers, and is encoded on one or more tangible non transitory software carriers, such as individual or combined use of a random or serial access device or substrate, a semiconductor memory device, transient or persistent random access memory, a magnetic, magnetic optical, or optical disk, or encoded on an artificially generated transmitted signal, for example, optical, electrical, or electromagnetic, transmitted using a sending and a receiving apparatus, where the interaction between the user and the software may be implemented by operatively coupling, to the local implementing computer, or a local computer connected to one or more remote computers through a local or wide area network, a display device which may implement liquid crystals or light emitting diodes, a keyboard, and a pointing device.

The inventor retains absolutely no liability for any implementation of this invention, and the invention is implemented exclusively at the risk and liability of the implementer.

In some embodiments, for quality control purposes, all components may be manufactured from scratch.

Calculations, formulas, and specific units are not in any way restrictive, are not be relied upon, are not required as presented to produce an embodiment of the invention, are provided exclusively as a courtesy to enhance enablement for those resizing components and or constructing alternative embodiments, and may contain inaccurate assumptions easily modified during practice, with all calculations utilized to select and estimate components and unit output being rough estimates that may vary greatly based on factors that include the type and quality of purchased and or manufactured components and embodiment construction, where embodiments may be constructed utilizing an effectively endless range of output and component configurations and selection processes.

Embodiments of the invention provide some or all of the following benefits over previously discussed predecessors:

1. Self-powered for free output: embodiments provide the first energy and motor system in the history of the known universe to not require an external fuel source. Embodiments can produce endless energy, and provide endless transportation range, until there is a system failure, and therefore may potentially produce energy and propulsion until gravity driven orbital drift causes the Earth to be consumed by the Sun in a few billion years—assuming the units and humans are still on Earth. Embodiments reduce transportation costs by allowing implementing vehicles to operate without fuel, allowing for effectively free and endless until system failure transportation range after purchase, and additionally allow for travel by supersonic jets and flying cars, which have been impractical principally as a result of fuel costs.

2. Clean: the manufacture and use of embodiments produces no notable harmful environmental byproducts, nor the potential for deaths associated with predecessors.

3. Continuous: embodiments produce electricity and propulsion that is continuous and stable.

4. Portable: embodiments are able to function as well in a basement closet as in a car.

5. Cyber attack proof: embodiments are self-contained thus require no hackable computer to operate and are therefore immune to computer viruses.

6. Blackout proof: embodiments are designed to be kept indoors and on-site, and are thus ideal for critical facilities such as hospitals and data centers that can't afford a blackout from failed power lines or plants.

7. Inexpensive: embodiments can be manufactured and operated at the lowest cost total cost possible, because they don't require fuel, installation and maintenance of power lines, an allocation of land, or degrading batteries.

8. Weatherproof: embodiments are self-contained for indoor use and therefore aren't vulnerable to environmental factors such as freezing temperatures, snow, rain, lightning strikes, or extreme weather events.

9. Eliminates energy output storage: because additional embodiments of this system can be utilized at peak times with limited cost, storage of energy is no longer relevant, for either utilities or homes, even for peak output needs.

10. Eliminates expensive power lines and fossil fuel pipe lines: because embodiments are designed to be kept on site, and any number of units can be utilized to meet peak power needs, power and fossil fuel transmission lines and their associated costs are now rendered irrelevant, thus substantially unburdening all economies globally of associated costs. Land currently holding power lines, as well as arrays of solar panels, wind turbines, and hydroelectric turbines, can be reclaimed to reduce visual pollution and make space for a growing population. Roofs of solar panels can be removed to allow for roof tiles that reflect heat to maintain a cool house in summer. No thinking person will ever want, nor could a functional government allow, any type of nuclear reactor—fission, fusion, cold (LENR)—in a car or home, leaving only now irrelevant power lines for transmission, thereby making those sources wholly irrelevant.

11. Potentially profitable: in a standard home use scenario, embodiments may be the only way for a unit owner to make a profit from selling energy back to the utility at wholesale rates.

12. Alleviates poverty: because energy is effectively free after embodiment purchase, and the purchase price is less per unit of output than other energy systems, embodiments reduce the cost of living and the cost of goods for every person on Earth, thus reducing poverty.

13. Powers water purification and pumping: 1 in 10 people live without access to clean water, while climate change driven droughts fuel conflicts. Because embodiments make energy nearly free over their useful lives, the energy intensive nature of evaporated water purification which removes nearly every contaminant with a higher boiling point than water, and potentially all others can be removed with a standard carbon filter and ultraviolet light—is no longer a barrier, nor is pumping, thus embodiments provide for the global resolution of clean water needs for individual consumption and agriculture.

14. Powers reduced water consumption: effectively eliminates the energy cost of operating electricity powered showers that require only a cold water pipe, and recirculate, filter to potentially cleaner than direct from pipe, and heat water, to provide exact continuous temperature and pressure control, as well as powering low voltage electric showerheads that mix air with water to provide the effect of the same output using dramatically less water.

15. Powers atmosphere cleaning: because an existing specialized laser can disassociate atmospheric carbon dioxide molecules into carbon molecules and oxygen molecules, and because embodiments can provide effectively unlimited and continuous completely clean energy, a power source is now available to reduce carbon dioxide in the air, and potentially other greenhouse gasses, if corresponding devices are developed.

16. Reduces nuclear and hydrogen weapon proliferation: because embodiments eliminate any need for any type of nuclear energy, including fission, fusion, and cold (LENR), each of which is or may be weaponizable and one step from nuclear weapons technology, and also eliminate the need for hydrogen, which a terrorist can obtain at a hydrogen fuel station to create a powerful compressed hydrogen explosion verifiable by watching a video of a balloon filled with hydrogen being lit on fire, I have provided us all a fundamentally safer world.

17. Therefore, a few applications of embodiments include powering: all transportation vehicles including automobiles, trains, jets, spaceships, cargo ships, cruise ships, tugboats, boats, submarines, hover boards, jet packs, including in vertical take off and landing configurations; powering electrical grids as well as homes, offices, factories, hospitals, and data centers that would like to disconnect from external power sources to end their recurring bill, be permanently immune from blackouts, use clean energy, and save money; televisions, washing machines, dishwashers, showers, and water pumps; portable consumer electronics, such as phones and laptops, through an internally installed miniaturized embodiment eliminating the need to recharge; personal rapid transport; home hydroponic production systems, including light, temperature control, and nutrient water circulation; spaceship electro magnetic ion drives using a fraction of the fuel of traditional rockets; high intensity laser powered solar sails, with the laser powered by a large number of these energy units on the surface of any space based body with a limited atmosphere; space tourism; video streaming planetary sampling probes journeying an unlimited number of years into the universe; space colonies; and inter galactic travel.

In some embodiments, including one complete embodiment, given the desired output of the motor and or generator, select and obtain corresponding magnets, and generator if used. In some embodiments, including one complete embodiment, the magnet structures are designed to support the magnets, and the magnets are selected to correspond to desired unit output, where sizes and types of magnets may vary upon factors including availability from magnet manufacturers and cost. In some embodiments, when implementing the motor and the generator, because the generator may optimally require a fixed rotational speed, it may be best to create each as a separate unit.

In some embodiments, including one complete embodiment, in reference to FIG. 1, because magnets may slowly have their field strength degraded when facing an opposing magnetic field for an extended of period of time, magnets are used to the extent practically possible that were manufactured to have the highest possible magnetic coercivity, meaning that the mix of materials used, and the manufacturing process, have made it as difficult as possible for a magnet to lose its directional force, by means which may include using specific materials and aligning material directional polarities prior to baking. In some embodiments, including one complete embodiment, Neodymium permanent magnets may be used. In some embodiments, Samarium-Cobalt magnets may be used, which may be four times as resistant to magnetic coercivity as Neodymium, but are significantly more expensive. In some embodiments, iron nitride permanent magnets may be used, produced utilizing abundant inexpensive iron, rather than rare earth metals, but such magnets are not broadly available at the time of disclosure. In some embodiments, substantially less expensive ferrite magnets may be used, which lose their directional force faster than standard permanent magnets. In some embodiments, other compositions, types, numbers, and sizes of magnets may be used. In some embodiments, which may include one complete embodiment, given magnets may slowly lose directional strength over time, additional magnet force output may be targeted to maximize longevity, and magnets may be longer than necessary, so that when magnetization degrades, the magnet structures can simply be further engaged to produce the same output.

In some embodiments, including one complete embodiment, permanent Neodymium magnets are used, which per square inch (645 square millimeters), may weigh around 0.3 pounds (0.13 kilograms), and may be of high grade type N52 which may produce around 20 pounds (9 kilograms) of repulsive force when at a half an inch (13 millimeters) distance opposing a magnet with the same specifications, however given that the magnets may be on average engaged based on distance at about half strength as they rotate, an average of 10 pounds (4.5 kilograms) of repulsive force may be assumed. The amount of force during engagement may be better approximated at the time magnets are obtained by securing one magnet on a scale, and placing an opposing magnet in a position representative of where it will be held in the magnet structure, and reading the weight, less the weight of the magnet alone on the scale. In order to select magnets with the highest field strength retention over time, pairs of magnets from different manufacturers may be measured for repellant force using the previously described scale method, then the pairs of magnets may be clamped together and held in place for an extended period of time, and then unclamped, and the repellant force again measured to select the magnets that have best retained their field strength.

In some embodiments, to determine the number of magnets to use, it may be the case that the greater the number of magnets used in the rotatable magnet structure, per unit of area, with a corresponding number in the rotationally fixed magnet structure, the smoother the magnetic repulsion, while also recognizing the greater the number the greater the design and assembly complexity, and that commodity magnets may only be readily available in certain sizes. In some embodiments, to approximate the number of magnets that may be in the rotationally fixed magnet structure, the width of the face of the magnet, as it sits within the circumference of the magnet structure, plus the width of the magnetic shielding, may be divided by the circumference of the rotationally fixed magnet structure interior. In some embodiments, including one complete embodiment, the design as it's built in CAD (Computer Aided Design) software may determine the exact number of magnets, ensuring angling and insulation so that the magnets do not providing repellent force on approach that prevents the inner magnet structure from effectively immediately spinning upon engagement with the outer magnet structure, or the rotating magnet structure may need to be provided initial rotational force. In some embodiments, including one complete embodiment, 5 magnets are held in the rotatable magnet structure, and a compliment of 12 magnets are held in the rotationally fixed magnet structure, where the inner magnet count multiplied by the repellent force of an inner structure magnet against an outer structure magnet, may be used for calculating the output.

To implement a generator, in some embodiments, including one complete embodiment, in reference to FIG. 1, 10,000 watt generator 1300 is obtained that may produce optimal output at 1800 revolutions per minute at 13.3 horsepower, which requires force of 38.8 pounds (18 kilograms) ((13.3 horsepower=n pounds of force*1,800 axle revolutions per minute)/5252 horsepower constant). In some embodiments, which may include one complete embodiment, a generator is selected that outputs the volts, amperes, and hertz of the desired final output for the relevant application, with a converter utilized to power internal embodiment components. In some embodiments, to approximately calculate the force required by the magnets to power the generator, or where an existing generator is to be powered by the embodiment, for example, in the place of a wind or water turbine, magnets may be selected that correspond to the force required to power such generator, which may at the time of disclosure be around 1.33 horsepower per 1,000 watts. In some embodiments, including one complete embodiment, 5 magnets in the rotatable magnet holder powering the output, with a complimentary 12 magnets in the rotationally fixed magnet holder, where each magnet segment of dimensions 1 inch (25 millimeters) width by 1 inch (25 millimeters) height by 1 inch (25 millimeters) length may provide around 10 pounds (4.5 kilograms) of continuous rotational force, for around 50 pounds (23 kilograms) of rotational force, with the exact engagement of the inner and outer magnet structures to be determined at the time of unit use, to produce stable optimal output by the generator. In some embodiments, the length of the magnets used in the embodiment may be extended to any length necessary to provide the required and or desired force. In some embodiments, including one complete embodiment, when implementing only a generator, the magnets may be of 1 inch (25 millimeters) height by 1 inch (25 millimeters) width by 5 inches (127 millimeters) in length, to produce 250 pounds (113 kilograms) of rotational force to power the generator, with the engagement of the magnets limited to that required to power the generator at optimal speed, which as the magnets degrade in force over time, structured may be further engaged to maintain ideal force and revolutions per minute. In some embodiments, if smaller magnets are inserted in sequence, if there is any repulsive force between the magnets, insulation as later described in this disclosure may be placed between them. In some embodiments, which may include one complete embodiment, to convert pounds of force to pound-feet of force, for the calculations of horsepower and corresponding components, identical gears may be placed on the axle of each the rotatable magnet structure and the generator, with the gears interconnecting, and with each having a radius of 1 foot. In some embodiments, to accurately measure the output of the embodiment, a torque gauge may be used to measure pound feet of force, and a tachometer may be used to determine revolutions per minute, or alternatively a dynamometer may be used which measures pound feet of force as well as revolutions per minute, and then horsepower may be calculated as torque multiplied by revolutions per minute with the result divided by the horsepower constant 5252.

In some embodiments, including one complete embodiment, when implementing a motor, 5 magnets in the rotatable magnet holder and 12 magnets in the rotationally fixed magnet holder may be used, where the rotatable magnet holder operates inside the rotationally fixed magnet holder, with the 5 rotatable magnet holder magnets at 1 cubic inch (16 cubic centimeters) providing 50 pounds (23 kilograms) of rotational force, the 5 rotatable magnet holder magnets of width 1 inch (25 millimeters), height of 1 inch (25 millimeters), and a total length of 24 inches (610 millimeters), where length may be achieved by a single continuous magnet, or sequential magnets appropriately insulated between each other using insulation in a later described manner if they repel each other at their sides, or in embodiments where additional lengths are used, length may be split between separate embodiments on each the front axle and rear axle. In some embodiments, the rotationally fixed magnet structure may instead also rotate, in turn rotating a generator axle or providing propulsion, where for example to allow for a generator or wheel to be mounted in place, rotational force may be first provided to a rotating an intermediary to allow for the sliding engagement of the magnet structures.

In some embodiments, to approximately calculate the pounds of force to use when implementing the embodiment as a motor, a horsepower may be targeted. The fastest motor currently available spins at around 100,000 revolutions per minute, and thus given the rotational speed of the unit is limited only by air resistance, when there is no load, an embodiment may be assumed to have a similar rotational rate, however accounting for a load and air resistance, an embodiment may be assumed to provide up to 10,000 revolutions per minute. To target a horsepower, that of a standard road car may be used, which is 250 horsepower at a maximum of 7,000 revolutions per minute, solving for 250 horsepower requires approximate pounds of force of 333 ((250=n pounds of force*7,000 revolutions per minute)/5252 horsepower constant), or 151 kilograms. Therefore, given the unit uses five magnets on the rotatable structure, providing a total of 50 pounds (23 kilograms) of repulsive force per inch (25 millimeters), and to provide more force than required to compensate for gradual degradation, magnets 13 inches (330 millimeters) in length may be used for 650 pounds (295 kilograms) of force. This will provide a car with unlimited range and no external fuel requirements. In embodiments where a tremendous amount of force is required, such as in jet engines, in addition to or in place of extending magnet lengths, a greater number of magnets may be used on the rotatable magnet holder with a corresponding number in the rotationally fixed magnet holder, to achieve effectively any level of horsepower.

In some embodiments, countless variations of the number, size, positioning, spacing, angling, insulation, and type of magnets may be used, which may, along with the quality of the magnets, and the quality of construction of the unit, together determine the method and accuracy of the calculations and the output of the unit.

In some embodiments, the magnet structures and magnets may be manufactured as a single continuous component, with magnetic fields instilled throughout the structures to produce a functionally equivalent effect. In some embodiments, the magnetic fields may be instilled throughout the structures by means which may include using specific materials suitable to create magnets, for example as neodymium, iron, and boron, and using a manufacturing process which may include powder metallurgy, sintered magnet process, rapid solidification, or bonded magnet process. In some embodiments, for example, sintered magnetic fields may be instilled in the structures by melting raw materials in a furnace, cooling them into ingots, pulverizing them into powder, sintering them into blocks within the structures, heat treating, and appropriately aligning and directing magnetic fields. In some embodiments, for example, bonded magnet fields may be instilled in the structures by preparing raw materials using melt spinning, cooling the melted raw materials, then pulverizing them into a powder, mixing them with a polymer, compression or injection molding them into the structure, and appropriately aligning and directing magnetic fields. A limitation of fully integrating the magnetic fields within structures, rather than using individual magnets, is that when the magnetic fields eventually lose adequate directional force, they can't be replaced without replacing the structure.

In some embodiments, including one complete embodiment, design and produce the rotatable magnet holder and the rotationally fixed magnet holder along with side panels. In some embodiments, including one complete embodiment, in reference to FIG. 1, a rotatable magnet holder 1100 and a rotationally fixed magnet holder 1101 are produced, along with magnet securing side panels 1102 1103, where the structures are designed to secure and support the magnets that were previously acquired. In some embodiments, including one complete embodiment, the rotatable magnet structure is fixed in place except for the ability to rotate by a rotatable axle, while the rotationally fixed magnet structure is mounted by an attached ring to a sliding bar to allow for changing its engagement with the rotatable structure. In some embodiments, where the outer magnet structure is the rotatable structure, the inner magnet structure may be fixed in place by a static axle, and the outer magnet structure may be connected to a rotatable axle, which may be connected through an axle hole in its reinforced side panel. In some embodiments, the rotatable magnet structure is on a sliding axle that interconnects with laterally fixed rotatable axles at either end. In some embodiments, instead of one of the magnet structures sliding, each magnet and any corresponding insulation within one of the magnet structures has its angle facing the opposing rotatable magnet structure, by means which may include hinging the magnet to the structure, and may include connecting all of the hinged magnet structures by a series of adjustable rods so they are all operable as one, with the degree of the rotations controlling the engagement of the rotating magnet structure, where the rotation degree may be controlled manually, or may by be individually controlled by means including linear actuators or hydraulic pistons, or may be collectively controlled by a linear actuator or hydraulic piston, and while such an embodiment has the benefit of reduced space consumption, it has the cost of adding a one or more point(s) of potential mechanical failure. In some embodiments, when implemented as a jet engine, the rotatable magnet structure may have a traditional jet turbine structure on its inside, or the outer magnet structure may rotate and have a traditional jet turbine structure on its outside. In some embodiments, magnet structures may be produced that can hold more magnets than are required, with empty space filled by non-magnetic blocks to achieve desired force. In some embodiments, including one complete embodiment, the rotationally fixed magnet holder extends its insulating encasement around the rotatable magnet structure when it's disengaged, to reduce magnetic forces from acting on anything outside the unit.

In some embodiments, including one complete embodiment, in reference to FIG. 1, the rotatable magnet holder 1100 holds magnets 1200 1201 1202 1203 1204, and the rotationally fixed magnet holder 1101 holds magnets 1205 1206 1207 1208 1209 1210 1211 1212 1213 1214 1215 1216, with the magnets arranged so that the rotatable and rotationally fixed magnet holders' magnets render repelling forces. In some embodiments, the magnet holders may be designed to hold, and do hold, smaller magnets in between the larger magnets, which benefit from the same manner of insulation and angling as the larger magnets. In some embodiments, which may include one complete embodiment, the magnets in the outer magnet holder may be of greater depth than those in the inner magnet holder, to provide greater repulsive force to the rotatable magnet holder without increasing the rotatable magnet holder's weight.

In some embodiments, including one complete embodiment, in reference to FIG. 1, to determine the angling of each magnet within the magnet structures, each aligns with the center axle in such a way that each provides the majority of its magnetic field force to one side of the center axle, where one side of the magnet may be aligned with the perimeter of the axle, such that the magnetic force of the magnet, when visualized as a line from magnet edge to axle, just misses the center axle, and furthermore making sure the magnets are not wasting force by pushing directly on the axle, or causing resistance on approach, and are pushing on one side of the axle in a consistent direction, additionally recognizing that magnetic fields are not perfectly linear and curve outward, and adding a compensating adjustment past the previous axle alignment, and any further adjustment past the previous adjustments to limit or eliminate resistance on approach to optimize rotation, where the angling to optimize continuous repulsive force may be later refined in conjunction with insulating materials that further direct the magnetic fields. In some embodiments, other means of angling and insulating magnets and their corresponding magnetic fields to provide continuous rotational force may be used.

In some embodiments, including one complete embodiment, in reference to FIG. 1, the diameter of the inner magnet structure may be roughly two times the magnet diameter along with insulation, plus the width of the axle, plus two times the minimum thickness required at any point, plus the magnet inset, and where the internal diameter of the outer magnet holder may be sized to allow for the opposing angled magnets to be insulated, spaced, and distanced to provide optimized rotational force.

In some embodiments, including one complete embodiment, in reference to FIG. 1, the rotatable magnet holder 1100 has a hole through the exact center that snugly fits axle 1006, with one end of axle 1006 passing through bearing 1007 mounted in axle support beam 1008, and the other end of axle 1006 passing through bearing 1009 mounted in support beam 1010.

In some embodiments, including one complete embodiment, in reference to FIG. 1, the thickness of the magnet holders is such that when all magnets are fitted and angled, there is not less than adequate thickness at any point in the support structure to support the magnetic forces without deforming.

In some embodiments, including one complete embodiment, in reference to FIG. 1, the spacing, angling, and insulation of magnets in the magnet structures, is based on ensuring engagement between the two magnet structures produces rotational force that is immediate, consistent, and continuous, including adequate insulation on the approach side of the magnets that eliminates repulsive force on approach so that the magnet structures will spin immediately when engaged. In some embodiments, which may include one complete embodiment, to control the non-linear nature of magnetic fields, the magnetic shielding on the approach side of each magnet may cover up to and including around the middle of the magnetic field. In some embodiments, including one complete embodiment, a pair of opposing magnetic fields from the embodiment in FIG. 1 is rotated for clarity and magnified in FIG. 1A to illustrate a rough approximation of directed magnetic field trajectories on the exposed side of the magnets. In some embodiments, including one complete embodiment, the magnets in the opposing magnet structures are insulated, spaced, and angled to optimize rotational consistency. In some embodiments, which may include one complete embodiment, all magnets, no magnets, or one structures magnets, may be spaced equally. In some embodiments, which may include one complete embodiment, each magnet in the inner magnet structure or the outer magnet structure is spaced to be engaged at an evenly spaced percent of maximum force. For example, if there are 5 magnets in the inner structure, they might be spaced with an approximate target of outer magnet structure engagement pattern as a percent of maximum force of 100% 80% 60% 40% 20% or 100% 75% 50% 25% 0%. In some embodiments, other means may be used to determine the spacing, angling, and insulation of the magnets to provide optimal rotation of the axle. In some embodiments, the shaped opposing magnetic fields provided for in this disclosure may instead be secured to the underside of a vehicle, and along a track, in corresponding magnetic field holders, with the magnetic fields angled, insulated, and directed in repulsion, to support vehicle propulsion and or lift.

In some embodiments, including one complete embodiment, in reference to FIG. 1, the magnets are inset within the magnet structures, where the inset is angled inward to secure each magnet in place, and additionally to adequately limit any potential repulsive forces inhibiting approach, the shielding and inset are of an amount that allows one or both of the opposing magnet structures when engaged to rotate continuously, optimally, and immediately. In some embodiments, including one complete embodiment, the minimum angle of the inset may be around 30 degrees and the length of distance of the inset covering the magnet surface on the non-approach side may be around a tenth of the magnet surface, and on the approach side may cover up to around half of the magnet surface, where the angle of the inset is adjusted to shape the magnetic field to provide optimal rotational force. In some embodiments, which may include one complete embodiment, the magnet structures' inset size and angle on the non-approach side may be no more than is required to physically hold the magnet in place. In some embodiments, which may include one complete embodiment, the magnetic insulation may be extended beyond the initial magnetic insulation inset overhang while adjusting angling of insulation to extend in a manner perpendicular to the magnet surface in order to further shape the magnetic field to further reduce resistance on approach and provide optimal rotational force. In some embodiments, which may include one complete embodiment, the outsides of the magnet structures engagement approach sides have an angled inset to limit repelling forces as the structures move laterally to become initially engaged. In some embodiments, alternative means of securing the magnets may be used, including magnets with concave sides, with matching magnet holder shapes, where the midpoint of the curve may be of adequate depth to hold the magnets in place, or the magnets having slits matching slit holders on the structures. In some embodiments, other methods of insulating the magnets may be used. In some embodiments, other means may be used that adequately secures of the magnets within the magnet structures. In some embodiments, which may include one complete embodiment, to overcome any initial repulsive forces, and optionally to provide for smoother sustained rotation, 1400 is a motor connected to battery switch 1801 which provides power from battery 1800 to initiate rotation of the rotatable magnet structure.

In some embodiments, a weighted momentum wheel is attached to the rotatable magnet structure, or the rotatable magnet structure holds adequate weight to sustain momentum, and once the desired speed and force of axle rotation has been achieved, the engagement of the magnet structures may be reduced, optimizing magnetic field preservation, while sustaining force and speed.

In some embodiments, including one complete embodiment, in reference to FIG. 1, to secure the magnets against lateral slippage, magnet holders are designed to be structurally enclosed except on the magnetic field exposure side and the magnet insertion side, with covers attached to the insertion side of each magnet holder, matching the size and shape of the sides of the magnet holders. In some embodiments, including one complete embodiment, the magnet holder covers are 0.5 inches (13 millimeters) thick and made of the same material as the magnet holders, where magnet holder cover 1102 is attached to rotatable magnet holder 1100 through inner magnet holder with screw holes drilled through both, and secured with screws 1104 1105, and magnet holder cover 1103 is attached to rotationally fixed magnet holder 1101 with screw holes drilled through both and attached with screws 1106 1107. In some embodiments, including one complete embodiment, the magnet holding structures or magnet holder covers, on the engagement approach side of the magnet structures, have the same inset insulation of the magnet holders, to limit repulsive forces on initial engagement.

In some embodiments, including one complete embodiment, in reference to FIG. 1, the magnet holders and magnet holder covers may be made out of a strong non-magnetic material that may also provide magnetic field shielding, and or redirection, and or absorption. In some embodiments, including one complete embodiment, a non-magnetic metal may be used such as Aluminum, which may be in the form of high strength Aluminum 7075, which has a yield strength of around 20,000 pounds (9,070 kilograms) of pressure per square inch (645 square millimeters). In some embodiments, which may include one complete embodiment, non-metal 3D printed filament may be used, for example polythermide, where such filaments, at the time of disclosure, may have rated strengths between 4,700 pounds (2130 kilograms) and 16,500 pounds (7,480 kilograms) of pressure per square inch (645 square millimeters), but may diminish in strength under extreme environmental conditions. In some embodiments, which may include one complete embodiment, MuMetal is to be used, which is defined by United States Military Specification 1441C, as primarily Nickel with a yield rating of up 44,000 pounds (19,960 kilograms) of pressure per square inch (645 square millimeters). In some embodiments, titanium may be used, if it is adequately non-magnetic, since it is stronger than high grade steel but may currently be around eight times more expensive. In some embodiments, which may include one complete embodiment, to reduce the weight of the magnet structures, hollow areas may be left to the extent they do not detract from structural resilience. In some embodiments, a material with magnetic properties such as steel may be used, with magnetic insulation added in all areas required to avoid or adequately reduce interaction with magnets. In some embodiments, including one complete embodiment, one or more layers of magnetic field shielding material is added around the magnets either directly or by being placed in magnet holder compartments, to shape the magnetic field in the previously explained manner, by limiting or preventing magnetic fields from emanating in undesired directions. If no additional magnetic insulation is used, the magnet holders may be of a material and thickness at all points that adequately shapes magnetic fields. In some embodiments, because magnetic fields may saturate materials and those materials diminish in insulation effectiveness, multiple materials may be layered within the magnet holding compartments to limit saturation. In some embodiments, including one complete embodiment, in reference to FIG. 1A, the magnets are enclosed by sheets 0.04 inches (0.1 millimeters) thick from the magnet outward of each iron+iron+tin+stainless steel+tin+aluminum, a layering combination that has been found to reduce external emission of permanent magnet fields by more than 90%, with additional layers added as needed until such shielding is adequate. In some embodiments, including one complete embodiment, the pattern to bend the insulation materials resembles that in FIG. 2, where the insulation materials may be formed using standard sheet metal fabrication tools, where insulation is provided by magnet bottom insulation 2000, magnet approach side insulation 2001, magnet approach side angled insulation 2002, magnet non-approach side insulation 2003, magnet non-approach side angled insulation 2004, magnet structure non-engagement side insulation 2005, magnet structure engagement side insulation 2006, magnet structure engagement side angled insulation 2007, and where each layer beyond the first will need to be appropriately extended to fit around the thickness of the previous layers. In some embodiments, any other type, thickness, pattern, and arrangement of insulation materials may be used that direct the magnetic fields in such a way that supports continuous rotation of either or both magnet holders. In some embodiments, which may include one complete embodiment, the insulation materials may only be on the approach sides of the magnets or magnetic fields. In some embodiments, any material or materials of any thickness may be used that allow the magnets or magnetic fields to provide optimal rotational force. In some embodiments, where there is residual magnetic resistance, the magnets may be inserted into the holders with power tools or inserted in smaller segments.

In some embodiments, which may include one complete embodiment, after having accounted for these details, specifications, and obtained components, molds consisting of an appropriate material may be made to cast the required components. The molds may be manually etched, or may be setup in CAD (Computer Aided Design) files, to then be processed by a CNC (Computer Numerical Control) machine, to etch each mold. While there are many versions of CNC machines, for many, the design process may allow for each part to be designed in a CAD program, which may export the design to the vendor neutral Initial Graphics Exchange Specification (IGES) format, developed by the United States Air Force for parts manufacturing, and may have the CNC machine's software convert the designs to G-Code instructions, which may control the movement of the CNC machine tools. The selected metal may then be melted and poured into the graphite molds. In some embodiments, including one complete embodiment, the components including the magnet holders may be 3D printed.

In some embodiments, which may include one complete embodiment, in reference to FIG. 1, because there are so many possible matches of commodity materials, components, and manufacturers, the best way to determine optimal output in practice may be for the primary design to be adjusted with varying spacing, angling, and insulation, with magnet holders created for each variation, and several different materials used, to determine which design provides optimal output force and rotational consistency with the purchased magnets and their corresponding magnetic fields. In some embodiments, which may include one complete embodiment, a gauss meter and a magnetic field visualizer are used to ensure the magnetic field is being insulated and shaped in an optimized manner, with corresponding adjustments made to the design and manufacture of corresponding components including the magnet holders and insulating materials.

In some embodiments, designs may be miniaturized, and produced using molds or 3D printing, to produce portable power units for embedding in portable consumer electronics such as phone and laptops, or to fit inside of the casing of standard batteries such as A, AA, AAA, C, D, or a watch batteries. If such unit sizes don't allow for full power needs to be met, embodiments can at least allow for self-recharging batteries.

In some embodiments, which may include one complete embodiment, optionally add an electric field around the magnets. In some embodiments, it may be desirable to wind uninsulated electrical wire around each magnet, and provide it with an electrical charge, to increase, and or maintain, and or restore magnetic directional force, where additional space may be created in the magnet holder to accommodate the wire, and an additional coating of a non-conductive material may need to be applied to the magnet holders' insulation or compartments to prevent the wires from sending electricity through the magnet holders, and the wiring is provided electricity from an attached generator or a separate power source. This may be beneficial in situations where the magnets must maintain directional force forever, or where extraordinarily high output is required, using minimal space and weight, such as in engines for jets or space vehicles while in atmosphere.

In some embodiments, including one complete embodiment, insert magnets in rotatable and rotationally fixed magnet holders and secure with side magnet holder covers. In some embodiments, including one complete embodiment, in reference to FIG. 1, the previously purchased and prepared magnets are each placed into each magnet holder's magnet compartments. In some embodiments, including one complete embodiment, in reference to FIG. 1, rotatable magnet holder 1100 receives 5 magnets 1200 1201 1202 1203 1204, and rotationally fixed magnet holder 1101 receives 12 magnets 1205 1206 1207 1208 1209 1210 1211 1212 1213 1214, with the inner and outer magnet holder magnets inserted and aligned to be magnetically repulsive, with the inner and outer magnet holder covers screwed on, where magnet holder cover 1103 is attached to rotatable magnet holder 1100 with screws 1104 1105 through threaded holes drilled through each, and magnet holder cover 1103 is attached to rotationally fixed magnet holder 1101 with screws 1106 1107 through threaded holes drilled through each. In some embodiments, the magnet holder covers may be secured by alternative means, including being bolted or welded in place.

In some embodiments, including one complete embodiment, build the support structure of the unit. In some embodiments, including one complete embodiment, in reference to FIG. 1, a support structure holds the axles that connect to the rotatable magnet structure, supports the sliding rotationally fixed magnet holder, and the remaining components, including a generator if implemented, where the support structure components are connected by means which may include welding. In some embodiments, which may include one complete embodiment, the support structure may be 3D printed or cast as a single component, which may additionally be an extension of the outer magnet holder 1101. In some embodiments, including one complete embodiment, in reference to FIG. 1, beams 1000 1001 1002 1003 are secured in a rectangle to form the base, with beam 1004 running through the center of the structure resting on beams 1000 and 1002 that has connected to it axle holders beams 1005 1006 with those beams having holes drilled in them to support bearings 1007 1009, through which the axle rotates. In some embodiments, which may include one complete embodiment, where a generator is used, in reference to FIG. 1, beam 1011 is attached to support beam 1002.

In some embodiments, including one complete embodiment, connect the rotatable magnet holder to its axle. In some embodiments, including one complete embodiment, in reference to FIG. 1, axle 1006 is inserted through rotatable magnet holder 1100 and welded into place, and in order to transfer force from the rotatable magnet holder as it rotates, rotatable magnet holder axle 1006 is slipped through its support beams 1005 1006 on either side which contain appropriately sized holes that may include a bearing, and rotatable magnet holder axle 1006 is coupled by means which may include welding to the axle of generator 1300, and or wheel or jet turbine 1400, and where to control the engagement of the rotatable and rotationally fixed magnet structures, rotationally fixed magnet holder 1100 has at its base rectangular ring 1012 around support beam 1004, which allows it to slide back and forth along the beam, utilizing handle 1013, to engage and disengage rotatable magnet holder 1101. In some embodiments, which may include one complete embodiment, axle 1006 is cast or 3D printed as an extension of magnet holder 1100, and axle support structures are cast or 3d printed as a continuous part of the support structure. The force and speed of the rotation may be primarily determined by the extent to which the magnet holders surround each other and the resistance of connected components. In some embodiments, the rotatable magnet holder axle may or may not be connected to additional axles or gears, as required by the application. In some embodiments, the rotatable magnet structure slides in and out of the rotationally fixed magnet structure, where the sliding axle of the rotatable magnet structure interconnects with fixed axles connected to the generator or the motor output axle.

In some embodiments, an engagement lever of the same material as the magnet structures moves the rotatable magnet structure 1100 in and out of a rotationally fixed magnet structure 1101 by connecting to and moving rotatable magnet structure axle 1006, where engagement lever 1014 holds onto a space on the axle 1006 between two extended axle perimeter extension rings, to move the axle without changing its speed, and is able to move back and forth.

In some embodiments, including one complete embodiment, connect rotatable magnet structure axle to the generator and or allow it to function as a motor axle. In some embodiments, including one complete embodiment when a generator is implemented, in reference to FIG. 1, generator 1300 is attached to the support structure beam 1011, by means which may include bolting or welding, with the axle of generator 1300 coupled to rotatable magnet structure axle 1006, by means which may include welding, to be able to receive rotational force from the axle connected to the rotating rotatable magnet structure, with the generator being of sufficient distance from the magnet structures to prevent magnetic interference, or may have placed before it additional magnetic shielding of the same type used for the magnet structures. In some embodiments, including one complete embodiment when implemented as a motor, a rotatable magnet holder axle 1006 functions as a motor axle by connecting, for example, on either side to tires or to a jet turbine blade, to provide propulsion.

In some embodiments, which may include one complete embodiment, attach electronically controlled engagement controller. The percent output of the embodiment is determined primarily by the rotatable magnet structure's percent engagement with the rotationally fixed magnet structure, and the resistance of connected components, with for example, full engagement producing maximum output, and no engagement in effect turning the unit off.

In some embodiments, which may include one complete embodiment, the engagement handle is pushed and pulled by linear actuator 1600, or a hydraulic piston and pump, which are wired to an external power source, or to a generator and or a battery, with control provided by a computer controlled relay board and software, as described in a later step.

In embodiments where the unit is used as a vehicle motor, there may be a mechanical connection between the gas petal and brake pedal and the engagement handle, thus eliminating the requirement that a vehicle have any electrical power source to control propulsion. In some embodiments, the engagement handle may be controlled by any number of alternative means.

In some embodiments, which may include one complete embodiment, add electric hydraulic piston with controller. In some embodiments, an electric hydraulic piston 1500 powered by hydraulic pump 1501, and controlled by hydraulic pump switch 1502, allows the embodiment to be angled, for applications including vertical take off and landing of a vehicle including a car, airplane, or spaceship. If an electric hydraulic piston is added, it is attached to the same structure as the embodiment, with the embodiment connected to the vehicle with hinges so that it can be angled. In embodiments where the hydraulic fluid would be exposed to freezing temperatures, insulation may be provided around the hydraulics and or an anti-freeze agent may be added to the hydraulic fluid. The hydraulic pump may be attached to an external power source, or an internal battery and or generator.

In some embodiments, which may include one complete embodiment, create computer control code. In some embodiments, which may include one compete embodiment, the engagement handle, and or the vertical take off and landing hydraulic piston, may be computer controlled, with the engagement handle adjusted through a directly or indirectly motorized device connected the Ethernet controlled relay board controlled by and connected to through a Ethernet crossover cable, a computer included in the unit, that runs custom software on startup, where when operating the engagement handle, the axle rotation is continuously monitored, and the engagement handle adjusted to achieve the desired speed, and for automatically setting and maintaining unit rotation speed when used as a generator and or motor, where the speed of rotation of the axle of the unit may be monitored by means which may include a hall effect sensor is aligned with a magnet on the rotating axle, which counts the time elapsed between magnet detections to calculate revolutions per minute. In some embodiments, which may include one complete embodiment, in the instance of energy generation, to maintain optimal rotation speed over time, because the magnets may lose force over time, the engagement controller may be adjusted to maintain optimal speed, based on readings of rotations per minute provided to the generator. In some embodiments, the continuous reading of a digital power consumption meter may be done by computer code to adjust the engagement controller to provide output to match demand, and thus optimize preservation of the units' magnets. In some embodiments, the computer may be a Raspberry Pi set on startup to run software developed in the Python language from the disclosed description, where the software is installed by connecting to the computer through telnet or secure shell, then at the command prompt typing “nano run.py” and adding and saving the software code, then at the command prompt typing “nano /etc/rc.local” and adding and saving the line “python /$location/run.py”, where $location is the path to the directory containing the previously created software file.

The software code to operate the computer connected relay board, in some embodiments, including one complete embodiment, provides functionality comprising:
import a library to connect to the relay;
import a library for accessing system resources;
import a library for hardware access to read the revolutions per minute of the axle;
import a library to pause program execution;
import a library to connect to the power consumption meter;
create a value holding whether or not the unit is to function as a generator;
create a variable holding the maximum watt output capacity;
create a variable holding the generator maximum revolutions per minute;
create a variable holding the axle circumference;
initialize a variable holding axle revolutions per minute;
create a variable holding the time the unit was started;
create variables holding the relay board connection, IP address, username, and password;
create variables holding the relay board on off state values;
create variables holding the state of each relay including the forward and backward engagement controller states, and the unit forward and backward states;
create a variable indicating whether or not a power consumption meter is to be used;
create variables holding the power consumption reader IP address, username, and password.
create a function to update the relay board, first establishing a connection to the relay board, if it has not been initialized, or has been dropped, then creating a string sequence of relay states, and sending the states to the relay board.
create a function to calculate the revolutions per minute at which the generator is being rotated;
   calculate the time elapsed as the current time minus the time started;
   set the time started to the current time;
   calculate the distance the axle has rotated;
   calculate the revolutions per minute.
create a function to set the revolutions per minute of the unit by controlling the magnet structures engagement;
   if the axle revolutions per minute is less than the desired revolutions per minute, set the engagement forward state to on for a moment;
   if the axle revolutions per minute is greater than the desired revolutions per minute, set the engagement backward state to on for a moment.
create a function to listen for user input;
   ready in any user key press;
   if the key pressed is the forward arrow, set the engagement backward state to off, and the engagement forward state to on;
   if the key pressed is the backward arrow, set the engagement forward state to off, and engagement backward state to on;
   if the key pressed is the up arrow, set the unit backward state to off, and unit forward state to on;
   if the key pressed is the down arrow, set the unit forward state to off, and the unit backward state to on;
   if the key pressed is the space bar, set all relay states to off;
   if a key was pressed, call the function to send the relay states to the relay board.
create the function called upon program start;
   read in any command line parameters;
   initialize a connection to the computer hardware, and register the rotational speed sensor.
   create a function binding the speed calculation function to the rotational speed sensor.
   continuously loop;
      proceed if functioning as a generator;
         if the power consumption meter is used, retrieve the current power consumption from the power consumption meter, and call the function to increase or decrease engagement and thus rotational speed based on current consumption;
         if the power consumption meter is not in use, run the unit at maximum output;
      listen for user input to control motor output and if received call the function to control engagement and thus rotational speed.

In some embodiments, where the engagement controller is computer controlled, Ethernet connected relay board 1700 is connected through an Ethernet crossover cable to computer 1709, while linear actuator 1600, which may utilize a reversible brushed direct current motor, in order to allow for its back and forth control, is wired to relays on the relay control board 1700 by wiring motor positive terminal to relay 1701 and relay 1703, and wiring motor negative terminal to relay 1702 and 1704, and hall effect sensor 1710 is aligned with magnet 1711 on the rotating axle 1006, with the hall effect sensor connected to computer 1709.

In some embodiments, where hydraulic piston 1500 and hydraulic pump 1051 control vertical take off and landing, motor 1504, which may be a reversible brushed direct current motor, is attached to hydraulic pump switch 1502, after having rod 1503 welded to its axle to push the buttons of the hydraulic pump switch 1502, and held in place by metal clamp 1504, with the wires from motor 1504 wired to positive terminal to relay 1701 and relay 1703, and wiring motor negative terminal to relay 1702 and 1704, or cut off the hydraulic pump switch and directly connect its wires to the relays in the pattern required to control operation.

In some embodiments, including one complete embodiment, optionally create and attach a protective enclosure. In some embodiments, including one complete embodiment, a protective enclosure 1900 houses all of the components, to protect the operator from the force of the embodiment and protect the electronic components from external elements, where the enclosure is made of sheets of a strong lightweight metal, such as aluminum, or a magnetically insulating material such as previously discussed layers of insulating material, or MuMetal, formed by means which may include fabrication or welding in the shape and dimensions of the support structure, and where the enclosure allows when appropriate, power connector 1800 to be externally accessible to the operator. In some embodiments, which may include one complete embodiment, the base of the enclosure may be manufactured as a continuous part of the support structure.

In some embodiments, including one complete embodiment, enjoy clean continuous portable self-powered energy and or propulsion. In some embodiments, including one complete embodiment, in reference to FIG. 1, there is no power switch because the unit doesn't require a battery to start, and so as soon as the unit is fully constructed, and the engagement handle appropriately engages the magnet structures, it provides clean free continuous self-powered energy and or propulsion. In some embodiments, when used to produce electrical power, once the unit is verified as correctly constructed, an experienced licensed electrician may attach the unit to a central power grid and engage the unit's engagement controller to produce optimal output. In some embodiments, when used to provide propulsion, mount the embodiment in the engine compartment, first removing any existing engine, and appropriately couple the embodiment to the vehicle and its controls to provide propulsion. In some embodiments, including one complete embodiment, should the magnets directional force ever degrade unacceptably, they may be switched for ones of acceptable directional force.

What is claimed is:

1. Structures designed to be capable of acting as a motor to provide propulsion and or power an electricity generator, with the invention comprising:
a first structure designed to hold magnetic fields, and designed to be able to rotate in opposition to a second structure designed to hold magnetic fields;
said structures capable of directing magnetic fields in such a way as to allow said first magnetic field holding structure to rotate in opposition to said second magnetic field holding structure, with or without the assistance of insulation of said magnetic fields.

2. Claim 1 further comprising structures capable of directing magnetic fields utilizing one or more layers of material able to direct magnetic fields.

3. Claim 1 further comprising the ability to control the engagement of said structures.

4. Claim 1 further comprising a weighted structure attached to an axle to be able to retain momentum.

5. A method performed by an apparatus comprising:
producing motion from repelling magnetic fields.

6. A method for constructing an apparatus comprising:
arranging magnetic fields such that when a first set of magnetic fields is in opposition to a second set of magnetic fields motion is produced.

7. A structure designed to be able to direct magnetic fields, with the invention comprising:
one or more layers of material able to direct magnetic fields.

8. A non-transitory computer-readable recording medium holding stored instructions, which when executed by one or more processing devices, cause the one or more processing devices to implement a method comprising:
detecting the current rotational speed of a rotating magnetic field structure, then to achieve a desired speed, increasing or decreasing engagement of the magnetic field structures by utilizing an electronic controller.

9. A non-transitory computer-readable recording medium holding stored instructions, which when executed by one or more processing devices, cause the one or more processing devices to implement a method comprising:
reading a power consumption meter, and or a utilizing a desired rotational speed, then adjusting the magnet structures engagement to support the desired power output or rotational speed.
